(19) United States
(12) Patent Application Publication
(10) Pub. No.: US 2021/0387642 A1
(43) Pub. Date: Dec. 16, 2021

(54) Device for Determining the Position of an Object Which Is Able to Move Relative to a Vehicle, and Vehicle Equipped Therewith

(71) Applicant: BRUSA Elektronik AG, Sennwald (CH)

(72) Inventors: Lukas Böhler, Wangs (CH); Hannes Stauss, Dornbirn (CH); Karl Bukotas, Sennwald (CH)

(21) Appl. No.: 17/284,870

(22) PCT Filed: Oct. 14, 2019
(86) PCT No.: PCT/EP2019/077726

§ 371 Date: Apr. 13, 2021

(30) Foreign Application Priority Data
Oct. 14, 2018 (DE) 10 2018 125 379.6

(51) Int. Cl. B60W 60/00; B60W 40/02; G01S 5/14; B60L 53/12; H04W 4/46; H04W 4/44

(52) U.S. Cl. CPC B60W 60/0015; B60W 40/02; G01S 5/14; B60L 53/12; H04W 4/46; B60W 2422/95; B60W 2554/4041; B60W 2554/80; B60W 2556/65; B60W 2756/10; H04W 4/44

(57) ABSTRACT

A device to determine a position of an object movable relative to a vehicle, wherein at least one vehicle-based communication unit is arranged on the outside of the vehicle, which communicates via radio waves with at least one object-based communication unit, and the at least one vehicle-based communication unit is coupled with a processing unit which is designed to determine the position of the object relative to a vehicle-centered coordinate system from the communication signals. The communication units are designed to determine distance between them by determining time-of-flight, and the processing unit is designed to determine the position of the object in the coordinate system by trilateration from at least two distance values determined based on the communication between at least three communication units. The communication units are designed to exchange vehicle-specific metadata, including acceleration, speed, or travel trajectory data, or object-specific metadata, such as location information of stationary objects.

### CROSS-REFERENCE TO RELATED APPLICATIONS

The present application is the U.S. National Phase of PCT/EP2019/077726, filed on Oct. 14, 2019, which claims priority to German Patent Application No. 10 2018 125 379.6, filed on Oct. 14, 2018, the entire contents of which are incorporated herein by reference.

### BACKGROUND

### Field

The invention relates to a device for determining the position of an object that is able to move relative to a vehicle, wherein communication units are arranged at least at three points on the outside of the vehicle, spaced apart, which communication units communicate with at least one object-based communication unit via radio waves, and wherein the vehicle-based communication units are coupled with a data processing unit which is designed to determine, from the communication signals thereof, the position of the object relative to a vehicle-centered coordinate system.

### Related Art

Determining the location of a movable object is a long-known practice in the field of vehicles, including, for example, the location of a keyless entry system relative to a reference system centered on the vehicle in order to determine whether the object (an electronic vehicle key) is inside or outside the vehicle. Such a method is known, for example, from DE 102 02 330 A1, in which the location is determined by means of a field strength measurement of a radio signal transmitted by the object. The object analyzes the field strengths of the signals from several vehicle-based communication units and uses this to determine whether the object is inside or outside the vehicle.

It is also possible to use the distances between the communication units determined by means of the measured field strengths, by means of a trilateration calculation operation to produce a location determination.

It is also known from WO 2016/180952 A1, DE 10 2015 209 755 A1 and DE 10 2016 217 532 A1 to determine the distance between two communication units by means of a time-of-flight time measurement.

The object of the invention is, in addition to allowing a more precise position determination of an object relative to a reference system centered on the vehicle, that further information about the object is made available.

The invention results from the features of the independent claims. Advantageous refinements and embodiments are the subject of the dependent claims. Further features, potential applications, and advantages of the invention result from the following description and from the explanation of embodiments of the invention, which are shown in the drawings.

According to the invention, the object is achieved in that the communication units are designed as distance measuring communication units which determine the distance between them by determining the time-of-flight (TOF), and the data processing unit is designed to determine the position of the object in the coordinate system by means of trilateration from at least two distance values determined by means of the communication between at least three communication units.

An object is understood to be any object provided with at least one communication unit. It can be an electronic key, a mobile communication device such as a smartphone, a beacon, a charging station for an electric vehicle, which is fixed on the ground, or another vehicle that is stationary or in motion.

A communication unit is a transmitting and receiving unit with a control device, for example, as described in WO 2016/180952 A1. Two communication units communicate on a common frequency, in particular, in the ultra-broadband UBB spectrum, and in the process exchange, according to the invention, further metadata in addition to the signals necessary for determining the distance, which metadata each of the receiving communication units relays to its control unit such that further information can be obtained about the object—for example, whether the object is a vehicle, a beacon, or a barrier. Location data or unique identification codes can also be transmitted so that, if there are multiple parallel communication paths, it is always possible to determine with which communication unit the connection is made.

This design allows a distance determination on the basis of a trilateration, with an accuracy of approximately 20 mm-70 mm and, if a plurality of vehicle-based communication units and/or the object are used, allows a position determination with even greater accuracy. Since a data processing unit connected to and controlling the vehicle-based communication units contains position information of the sensors in the vehicle-centered coordinate system, the position of each object-based communication unit communicating with at least two vehicle-based communication units can be calculated.

According to one embodiment of the invention, the object is another vehicle. Accordingly, especially during driving, the distance, position and location of another vehicle in the vehicle's own coordinate system can be determined very precisely due to the multiple vehicle-based communication units, with a similar number of communication units of the other vehicle. In this case, the object-based communication units, which are part of another vehicle, are designed to transmit vehicle-specific metadata, in particular acceleration, speed or travel trajectory data. Such an exchange of metadata, for example, in an autonomously operated vehicle, a machine-determined intention to maneuver the vehicle (pulling out, accelerating, braking, changing lanes), can increase safety during autonomous driving—especially in heavy traffic.

According to an alternative embodiment of the invention, the object is designed as a stationary communication beacon, preferably on a lock, a gateway, or a barrier area. Such a communication beacon, which sends metadata during the communication, in particular 2D or 3D topography data of a system such as an underground parking garage, enables a vehicle to maneuver within the system—for example, to drive to an available parking space or an exit. In this way, the vehicle can determine where it is within the system by communicating with a plurality of beacons.

In particular, if the object also includes at least two communication units, a position or orientation of the object in the vehicle-centered coordinate system can also be determined in addition to the position. Additional positional information must be exchanged between the communication units during communication for this purpose. In particular, if the object has, for example, two communication units, it is necessary to at least transmit information about the distance between the communication units and the identifier. However, further metadata are preferably transmitted from which further information about the object can be obtained.

According to an advantageous embodiment of the invention, at least two, preferably three, vehicle-based communication units are provided. With two vehicle-based communication units, a position can be determined in the plane if both vehicle-based communication units have undisturbed direct radio contact, without reflections, with at least one object-based communication unit. The position can be determined in three-dimensional space with three vehicle-based communication units. Preferably, however, more than three, in particular eight, vehicle-based communication units are arranged on the periphery of the vehicle—two at the front, two each on the left and right, and two at the rear. In this way, a direct radio connection can be achieved via two communication units over the entire periphery of the vehicle—that is, without a “blind spot”- and in many cases even with three communication units, which improves the accuracy of the position determination.

Communication units on the vehicle are preferably arranged laterally in the region of the front doors, preferably in front door handles and/or front door sills. The arrangement in door sills is suitable for the detection of low objects, in particular objects arranged on the ground, such as a charging station for an electric vehicle. In addition, further vehicle-based communication units should preferably be provided in the rear door handles and/or door sills.

At least one vehicle-based communication unit is preferably provided in the rear region of the vehicle. Two communication units are particularly preferably arranged on both sides of a rear license plate in order to be able to perform a position determination for objects located behind the vehicle. According to an advantageous development of the invention, the vehicle is designed as a motor vehicle with an electric drive, which has an inductive energy transmission device of the vehicle on its underside, and the object is designed as a ground pad module (GPM) which is mounted on the ground and can be inductively coupled with the inductive energy transmission device. By means of this development, a vehicle can be positioned above such a ground-mounted energy transmission device.

The position determination for a GPM in relation to a vehicle (more precisely, its counterpart, a car pad module (CPM) attached to the vehicle base) is conventionally carried out by means of detecting electromagnetic fields on the GPM. For this purpose, a plurality of coils are attached at the edge of the GPM's charging coil. The current flow through the coils creates a weak electromagnetic field in the surroundings, which requires fine sensors for low field strengths which must, at the same time, withstand high field strengths during the charging process. In contrast, the invention allows decoupling the power transmission from the GPM to the CPM, with position determination also being possible during the charging process.

According to an advantageous development, the ground-mounted energy transmission device (GPM) has at least three, preferably four, object-based communication units—that is, the GPM—arranged with spacing. When a plurality of communication units of the GPM is used, a single vehicle-based communication unit, which is preferably part of the CPM, is sufficient for determining the position of the GPM, since the position data of the communication units of the GPM can be transmitted via the communication channels together with a GPM coordinate system, and the data processing unit can determine the position and preferably also the relative position (orientation) on the basis of the distance data together with the position data in the GPM coordinate system. The more vehicle-based communication units can communicate with the communication units of the GPM, the more precise the position and orientation determination becomes.

According to a further advantageous development of the invention, an object-based communication unit is arranged in a remote control key used for operating the vehicle. As such, the remote control key is the object. This approach can provide an alternative to the common keyless systems based on field strength measurements. A synergy arises especially for electrically powered vehicles if the same communication units can be used for the GPM-CPM positioning, as well as for the keyless functionalities.

According to an advantageous development of the invention, the communication units communicate with one another using ultra-broadband communication (UBB). This frequency band enables high positioning accuracy.

Finally, the invention relates to a motor vehicle which contains one of the embodiments of the device described above.

### BRIEF DESCRIPTION OF THE DRAWINGS

Further advantages, features and details result from the following description, in which—with reference to the drawings—at least one embodiment is described in detail. Identical, similar, and/or functionally identical parts are provided with the same reference signs.

In the drawings:

FIG. 1: is a schematic plan view of an electrically powered motor vehicle, next to a GPM;

FIG. 2: is a schematic plan view of two motor vehicles communicating with each other; and

FIG. 3: is a schematic plan view of the surroundings of an electrically operated motor vehicle.

### DETAILED DESCRIPTION

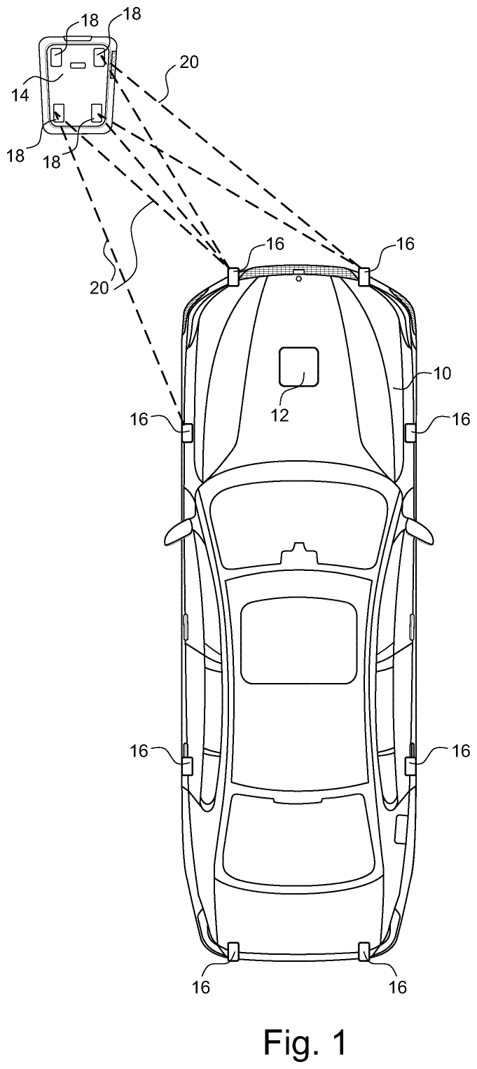

FIG. 1 shows an electrically operated vehicle 10; the drive or battery units are not shown. The vehicle 10 has a CPM 12 on the underside, which works together with a GPM 14 fastened to the ground, in order to transmit electrical energy inductively. For this purpose, the GPM 14 is coupled with an electrical power network via lines, which are not shown, and includes at least one coil, which is not shown, which works together with a coil of the CPM 12 which is arranged above for the inductive transmission of electrical energy with a power of several kW. For this purpose, however, the CPM 12 of the vehicle 10 must be located as directly above the GPM 14 as possible. A driver and/or an autonomous control device of the vehicle 10 should therefore be able to move and stop the vehicle 10 in such a way that the CPM 12 comes to a halt over the GPM 14. For the positioning, it is therefore important to know the position and orientation of the GPM 14 relative to the vehicle 10 at every moment of the movement of the vehicle 10.

The vehicle 10 is therefore provided with a number of vehicle-based communication units 16 which are connected to a common control unit. A vehicle-based communication unit 16 (not shown) can also be arranged on the CPM 12.

In the same way, a number of object-based and/or GPM-based communication units 18, which are likewise connected to a common control unit, are arranged on the GPM 14.

The vehicle-based communication units 16 each make contact with the object-based communication units 18 and determine the respective distances 20, indicated by dashed lines, via a time-of-flight data exchange. At the same time, orientation information relative to the given coordinate system—that is, the vehicle-based or GPM-based coordinate system—is transmitted during the data exchange, such that the vehicle 10 and/or the GPM 14 can determine the position and orientation of the other body from the calculated distances 20 and the transmitted location data. As such, in the same way that the vehicle 10 can determine the position and orientation of the GPM 14 in the vehicle's own coordinate system, the GPM can also preferably determine the position of the vehicle 10 in its own coordinate system, for example, in order to visually or acoustically signal such information to the driver and to facilitate the positioning.

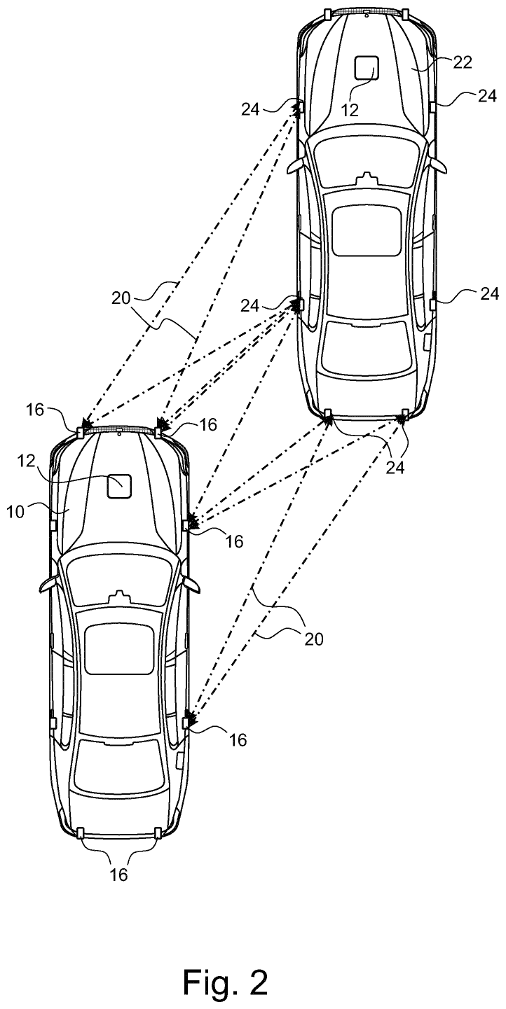

Two vehicles 10, 22 can be seen in FIG. 2. In the case shown, these are two, moving, electrically powered vehicles with CPM 12—but this is not necessary. Vehicle-based communication units 16 of the first vehicle 10 communicate with second communication units 24, which are, from the point of view of the first vehicle 10, object-based communication units, and from the point of view of second vehicle 22 are vehicle-based communication units. As a result of the plurality of distance measurements 20, the position and orientation of the second vehicle 22 relative to the first vehicle 10—that is, in its coordinate system—can be determined with high accuracy. In this case, metadata of the vehicle operation are preferably also transmitted, such that in addition to the pure geometric information, further information can also be exchanged, which is particularly advantageous if one of the vehicles 10, 22 or both vehicles 10, 22 drive autonomously. The system can ensure that data regarding trajectories or actions are also transmitted by a vehicle to the correct vehicle. Otherwise, the information—for example, that a lane change is about to be initiated—could be sent to any vehicle in the communication range. However, because of the system, the vehicle in question is known relative to the observer, and two vehicles can communicate regarding the details of the lane change.

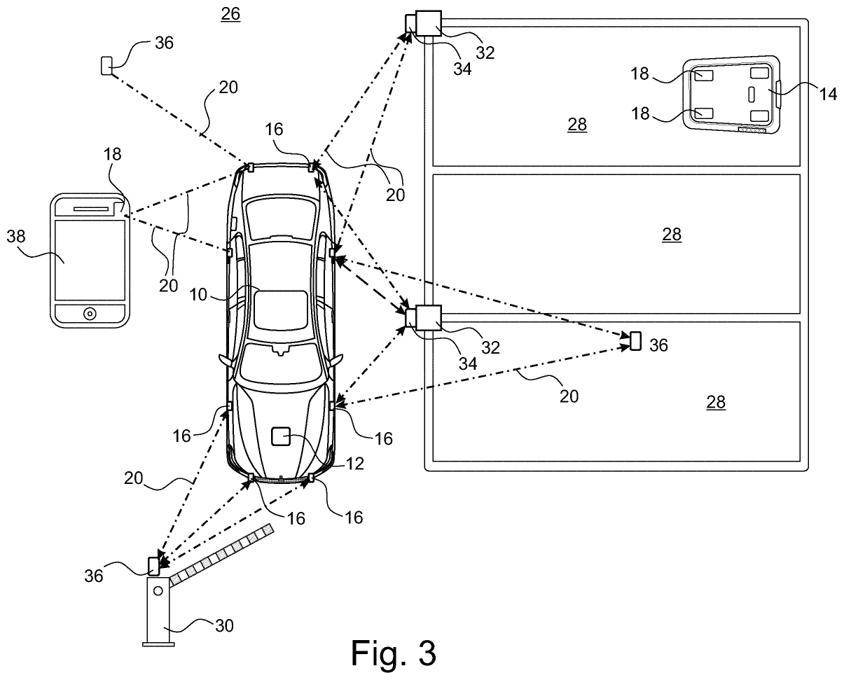

FIG. 3 shows a vehicle 10 in a parking garage 26 which, in addition to parking spaces 28, has a barrier 30. A GPM 14 is fixed to the floor in one of the parking spaces 28. There are also two beacons 32 with stationary communication units 34 between the parking spaces 28, in order to facilitate or enable maneuvering the vehicle 10 in the parking garage 26. In addition, further second stationary communication units 36 can also be arranged on the ceiling, for example. By determining the respective distances 20, a movement of the vehicle 10 in the parking garage 26 can be controlled and monitored autonomously, whether this is because the data from the—from the point of view of the vehicle 10—object-based and/or stationary communication units 34, 36 are evaluated by a control unit in the vehicle 10, or the data of the vehicle 10 are transmitted to a control unit that controls the stationary communication units 34, 36, which takes over control of the vehicle. Other preferred applications are payment systems and guidance systems for parking lots. For positioning with simultaneous communication, it is ensured that the correct vehicle or object is addressed when data is exchanged. If automatic billing transactions were to be carried out at barriers only via a wireless channel, it would not be possible to determine with certainty which vehicle is being addressed. It could also be the vehicle behind that of the vehicle 10 situated directly at a barrier. A further preferred application is controlling access to environmental zones.

FIG. 3 also shows a personal communication device 38 having an object-based communication unit 18. The object 38 can be an electric key or a smartphone or the like. By means of the arrangement, the distances between the personal communication device 38 and the vehicle 10 can be determined, so that it is possible to determine whether the communication device 38 is located inside or outside the vehicle 10. An alternative keyless system can thus be provided by means of the device according to the invention.

Although the invention has been illustrated and explained in greater detail by means of preferred embodiments, the invention is not limited by the disclosed examples and other variations may be derived therefrom by a person skilled in the art without departing from the scope of protection of the invention. It is therefore clear that there are a plurality of possible variations. It is also clear that embodiments cited by way of example actually only constitute examples that are not to be interpreted in any way as a limitation of the scope, of the potential applications, or of the configuration of the invention. Instead, the preceding description and the description of the figures allow the person skilled in the art to specifically implement the embodiments, wherein the person skilled in the art has knowledge of the disclosed inventive concept and is able to make numerous changes, for example, with respect to the function or the arrangement of individual elements cited in an embodiment, without departing from the scope of protection, which is defined by the claims and their legal equivalents, such as a further explanation in the description.

### LIST OF REFERENCE SIGNS

10 vehicle
12 CPM
14 GPM
16 vehicle-based communication units
18 object-based communication units
20 distances
22 second vehicle
24 second communication units
26 parking garage
28 parking spaces
30 barrier
32 beacon
34 stationary communication units
36 second stationary communication units
38 personal communication device

1. A device to determine a position of an object that is able to move relative to a vehicle, wherein at least one vehicle-based communication unit is arranged on an outside of the vehicle, the at least one vehicle-based communication unit configured to communicate with at least one object-based communication unit via radio waves, and wherein the at least one vehicle-based communication unit is coupled with a data processing unit, the data processing unit designed to use communication signals to determine the position of the object relative to a vehicle-centered coordinate system, wherein the communication units are designed as distance measuring communication units to determine a distance between them by determining a time-of-flight, and the data processing unit is designed to determine the position of the object in the coordinate system from at least two distance values determined based on communication between at least three communication units using trilateration, wherein the object is another vehicle and the vehicle-based communication units and the at least one object-based communication unit, which is part of another vehicle, are designed to exchange vehicle-specific metadata with each other, including acceleration, speed, or travel trajectory data.

2. A device to determine a position of an object that is able to move relative to a vehicle, wherein at least one vehicle-based communication unit is arranged on an outside of the vehicle, the at least one vehicle-based communication unit configured to communicate with at least one object-based communication unit via radio waves, and wherein the at least one vehicle-based communication unit is coupled with a data processing unit, the data processing unit designed to use communication signals to determine the position of the object relative to a vehicle-centered coordinate system, wherein the communication units are designed as distance measuring communication units to determine a distance between them by determining a time-of-flight, and the data processing unit is designed to determine the position of the object in the coordinate system from at least two distance values determined based on communication between at least three communication units using trilateration, wherein the object is a navigable topography, and a number of communication beacons are arranged spaced apart, wherein the communication beacons are connected to a data memory, the data memory comprising metadata for location description of the topography, and the communication beacons capable of being activated to transmit the metadata to at least one vehicle-based communication unit as part of communication therewith.

3. The device according to claim 1, wherein at least two vehicle-based communication units are provided.

4. The device according to claim 3, wherein the vehicle-based communication units are arranged laterally in a region of front doors of the vehicle.

5. The device according to claim 1, wherein at least one vehicle-based communication unit is arranged in a rear area of the vehicle.

6. The device according to claim 1, wherein at least one vehicle-based communication unit is arranged in a front area of the vehicle.

7. The device according to claim 1, wherein the data processing unit is designed to detect distance values from a plurality of the vehicle-based communication units with a plurality of object-based communication units in order to increase accuracy of the distance determination from the object.

8. The device according to claim 1, wherein the vehicle is designed as a motor vehicle with an electric drive which has an inductive, vehicle-based energy transmission device on its underside, and the object is designed as a ground-mounted energy transmission device capable of being inductively coupled therewith.

9. The device according to claim 8, wherein the ground-mounted energy transmission device has at least three object-based communication units arranged with spacing.

10. The device according to claim 8, wherein the vehicle-based energy transmission device has at least one vehicle-based communication unit.

11. The device according to claim 1, wherein an object-based communication unit is arranged in a remote control key for operating the vehicle.

12. The device according to claim 2, wherein the object is a lock, a gate or a bather area.

13. The device according to claim 2, wherein the object is a parking garage.

14. The device according to claim 1, wherein the communication units communicate with each other by fusing ultra-broadband communication.

15. A motor vehicle comprising a device according to claim 1.

16. A motor vehicle comprising a device according to claim 2.

17. The device according to claim 1, wherein at least three vehicle-based communication units are provided.

18. The device according to claim 4, wherein the vehicle-based communication units are arranged in front door handles and/or front door sills of the vehicle.

19. The device according to claim 5, wherein two vehicle-based communication units are arranged in the rear area of the vehicle on sides of a license plate.

20. The device according to claim 6, wherein two vehicle-based communication units are arranged in the front area of the vehicle inside headlight units.
